(19) United States
(12) Patent Application Publication
(10) Pub. No.: US 2016/0113256 A1
(43) Pub. Date: Apr. 28, 2016

(54) Device for Dispensing a Fish Attracting Substance

(71) Applicant: DORIS INTERNATIONAL LIMITED, Auckland (NZ)

(72) Inventor: Robert Van Heiningen, Waimauku (NZ)

(73) Assignee: Doris International Limited, Auckland (NZ)

(21) Appl. No.: 14/896,467

(22) PCT Filed: Jul. 9, 2014
(86) PCT No.: PCT/NZ2014/000140

§ 371 Date: Dec. 7, 2015

(30) Foreign Application Priority Data
Jun. 6, 2013 (NZ) 611579

(51) Int. Cl. A01K 85/01; A01K 97/02

(52) U.S. Cl. CPC A01K 85/01; A01K 97/02

(57) ABSTRACT

The invention disclosed is a fish attractant release device and methods therefore. The device has a housing having at least a first chamber which can hold a fish attracting substance. There is at least one fish attracting substance discharge aperture, and a valve member to seal the discharge aperture. A biasing means at least in part within the housing, urges the valve means into sealing engagement with the discharge aperture to a desired pressure. When in use, an increase in hydrostatic water pressure external of the housing causes unseating of the valve member from the sealing engagement with the discharge aperture, once the desired pressure is met. This then permits the fish attracting substance to discharge via the discharge aperture.

### TECHNICAL FIELD OF THE INVENTION

The present invention relates to a device and method for dispensing a fish attracting substance, and more particularly, though not solely, to a device and methods for dispensing a fish attracting substance at a desired specific depth in the water column, for example to release attractants in a sea or lake environment.

### BACKGROUND OF THE INVENTION

The use of fish attracting substances in addition to baited hooks or lures is commonplace with both recreational and commercial fishermen. Such substances usually comprise ground up bait and/or fish oils and are known colloquially as berley or chum. These substances are dispersed into the water column, more so if there is a current running. The substances are highly attractive to the fish which are drawn to the source and hence to the vicinity of the baited hooks or lures.

The fish attracting substances are usually housed in a purpose built container known as a ‘berley dispenser’ which is lowered into the water column on its own dedicated line although in some instances can be tied to the anchor line or even the fishing line itself.

The dispensers come in many forms but typically comprise either a bag, basket or tubular container containing perforations to enable the berley to mix with the water and escape via the perforations into the adjacent water column.

Whilst these simple devices can function adequately, they are found to be not particularly efficient because a large portion of the fish attracting substance can escape prematurely into the water column ‘on the way down’ during the lowering operation where it is not required. This can be particularly pronounced if the targeted species is located at a considerable depth.

The aim of the present invention is to provide a device that utilises a liquid and/or viscous fish attracting substance that will only begin to dispense the fish attracting substance after a preset depth has been reached.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

It is an object of the present invention to provide an improved fish attractant dispensing device, or to overcome the above shortcomings or address the above desiderata, or to at least provide the public with a useful choice.

### BRIEF DESCRIPTION OF THE INVENTION

In a first aspect the present invention consists in a device for dispensing a fish attracting substance comprising or including:
a housing having at least a first chamber;
said first chamber to hold a fish attracting substance;
at least one fish attracting substance discharge aperture;
a valve member to seal said at least one discharge aperture;
a biasing means at least in part within said housing, to in use urge said valve means into sealing engagement with said at least one discharge aperture to a desired pressure;
and wherein in use, an increase in hydrostatic water pressure external of said housing causes unseating of said valve member from sealing engagement, once said desired pressure is met, with said at least one discharge aperture to then permit said fish attracting substance to discharge via said at least one aperture.

In one embodiment of the first aspect, said biasing means is a gas, or spring, adapted for setting or being set to said desired pressure.

Preferably there are a number of said discharge apertures around said cylinder adjacent a junction between said first and second chambers.

Preferably wherein the, or each, said discharge aperture is located in said second chamber.

Preferably there is a re-sealable opening for charging said first chamber, located at an end face of said first chamber.

Preferably a gas is used as said biasing means.

Preferably said valve member is unseated by either of both of
a. Direct action of said hydrostatic pressure on said valve member, and/or
b. Indirect action of said hydrostatic pressure.

Preferably said direct action is through said discharge apertures onto said valve member to unseat it.

Preferably an actuator sits behind said fish attractant and urges said fish attractant toward said valve member, wherein when said valve member unseats, at least some of said fish attractant is caused to be released via said discharge apertures.

Preferably said indirect action is via said actuator being exposed to said hydrostatic pressure to thereby unseat said valve member.

Preferably there is a mixing element for the fish attracting substance which is preferably housed within the first chamber and comprises a ball bearing.

Preferably said housing is of a hollow cylindrical shape divided internally such that said first chamber is at one end and there is a second chamber at the other end.

Preferably said first and second chambers are in communication with each other and separated by said valve member.

Preferably said biasing means acts on a back side of said valve member facing into said second chamber.

Preferably said biasing means is set to said desired pressure by a piston located in said second chamber of said housing.

Preferably there is a calibrated scale on a plunger of said piston assembly or external to said housing, to allow setting of said desired pressure.

In another aspect the present invention consists in a device for dispensing a fish attracting substance comprising:
a housing having at least first and second chambers;
said first chamber provided with a re-sealable opening for charging said chamber with a fish attracting substance;
at least one fish attracting substance discharge aperture;
a valve member to seal said at least one discharge aperture; said second chamber charged with a gas;
means within said second chamber to urge said valve means into sealing engagement with said at least one discharge aperture;
and an actuator movable, in use, by an increase in hydrostatic water pressure to cause unseating of said valve from sealing engagement with said at least one discharge aperture to permit said fish attracting substance to discharge via said at least one aperture.

Preferably said means within said second chamber to urge said valve means into sealing engagement with said at least one discharge aperture comprises a spring.

In yet another aspect the present invention consists in a device for dispensing a fish attracting substance comprising or including:
a housing having at least a first chamber;
said first chamber to hold a fish attracting substance;
at least one fish attracting substance discharge aperture, sealed between said first chamber and externally of said housing,
wherein said seal will open said at least one discharge aperture when a desired hydrostatic pressure external of said housing is met, with said at least one discharge aperture to then permit said fish attracting substance to discharge via said at least one aperture.

Preferably said seal is a rupture seal designed to rupture at said desired hydrostatic pressure.

Preferably said seal is provided by a valve biased against said discharge aperture by a set desired pressure, to match said desired hydrostatic pressure, said valve then opening said discharge aperture to allow release of said fish attractant.

In another aspect still the present invention consists in a method of use of a device for dispensing a fish attracting substance according to any one of claims 1 to 21, comprising or including the steps of,
Charging said first chamber with a fish attracting substance,
Charging said second chamber to a desired pressure equal to a hydrostatic pressure for a desired release depth,
Wherein on release into a liquid environment said device will sink and at said desired release depth, release said fish attractant device.

Preferably said device is reusable.

Alternatively said device is single use.

In yet still another aspect the present invention consists in a kit of parts for a device for dispensing a fish attracting substance, comprising or including,
a housing having at least first and second chambers;
said first chamber provided with a re-sealable opening for charging said chamber with a fish attracting substance;
at least one fish attracting substance discharge aperture;
a valve member to seal said at least one discharge aperture;
a biasing means at least in part within said second chamber to in use, urge said valve means into sealing engagement with said at least one discharge aperture to a desired pressure;
and an actuator movable, in use, by an increase in hydrostatic water pressure external of said housing to cause unseating of said valve member from sealing engagement, once said desired pressure is met, with said at least one discharge aperture to permit said fish attracting substance to discharge via said at least one aperture, and
a supply of one or more charges of fish attractant for charging said device.

Preferably said kit also includes a charge device to charge said second chamber to said desired pressure.

Preferably said biasing means within said second chamber is a gas, or spring, adapted for setting to said desired pressure.

Preferably said charge device is a pump, canister or similar for connecting to said device and charging with said gas.

In another aspect the present invention consists in a device for dispensing a fish attracting substance as described herein with reference to any one or more of the accompanying drawings.

In another aspect the present invention consists in a method for dispensing a fish attracting substance as described herein with reference to any one or more of the accompanying drawings.

In another aspect the present invention consists in a kit of parts as described herein with reference to any one or more of the accompanying drawings.

As used herein the term “and/or” means “and” or “or”, or both.

As used herein “(s)” following a noun means the plural and/or singular forms of the noun.

The term “comprising” as used in this specification means “consisting at least in part of”. When interpreting statements in this specification which include that term, the features, prefaced by that term in each statement, all need to be present, but other features can also be present. Related terms such as “comprise” and “comprised” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

The entire disclosures of all applications, patents and publications, cited above and below, if any, are hereby incorporated by reference.

To those skilled in the art to which the invention relates, many changes in construction and widely differing embodiments and application of the invention will suggest themselves without departing from the scope of the invention as defined in the appended claims. The disclosures and the descriptions herein are purely illustrative and are not intended to be in any sense limiting.

Other aspects of the invention may become apparent from the following description which is given by way of example only and with reference to the accompanying drawings.

### BRIEF DESCRIPTION OF THE DRAWINGS

In further describing the invention by way of a preferred embodiment, reference will be made to the accompanying drawings in which:

FIG. 1 is a perspective view of the assembled device,

FIG. 2 is a perspective view disassembled,

FIG. 3 is a sectioned side elevation,

FIG. 4 is a detailed view of portion “A”,

FIG. 5 is a detailed view of portion “B”,

FIG. 6 is a sectioned side elevation with the internal components removed,

FIG. 7 is a detailed view of portion “C”, and

FIG. 8 is a detailed view of portion “D”.

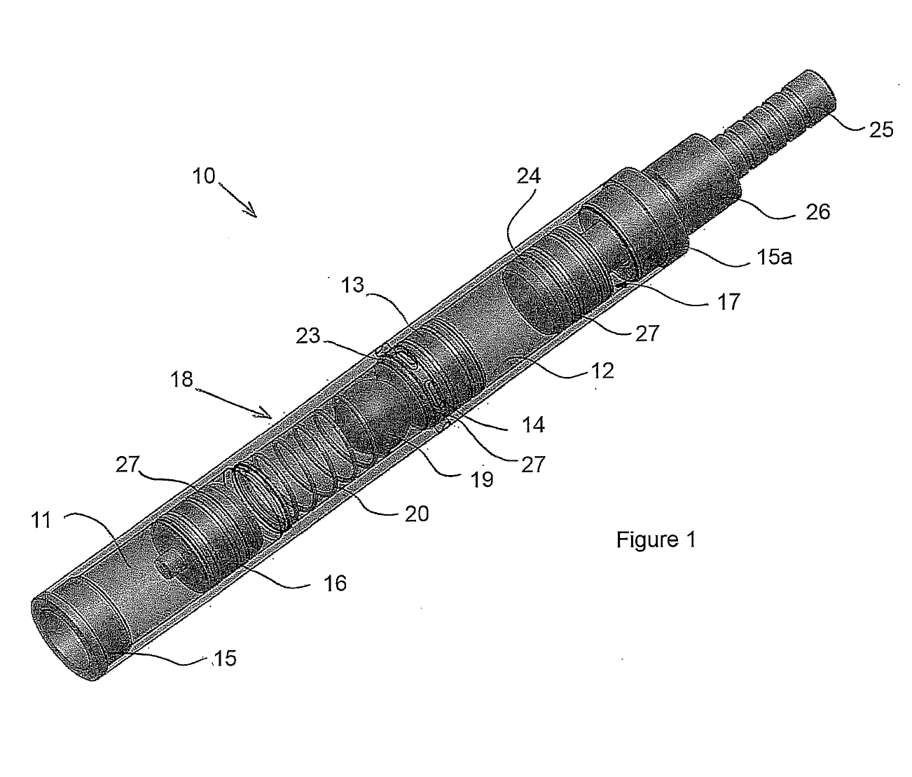

Referring firstly to FIG. 1 of the drawings, the device body is, for ease of machining or moulding, of cylindrical or tubular shape and configuration, however it will be appreciated that other shapes are possible without departing from the scope of the invention.

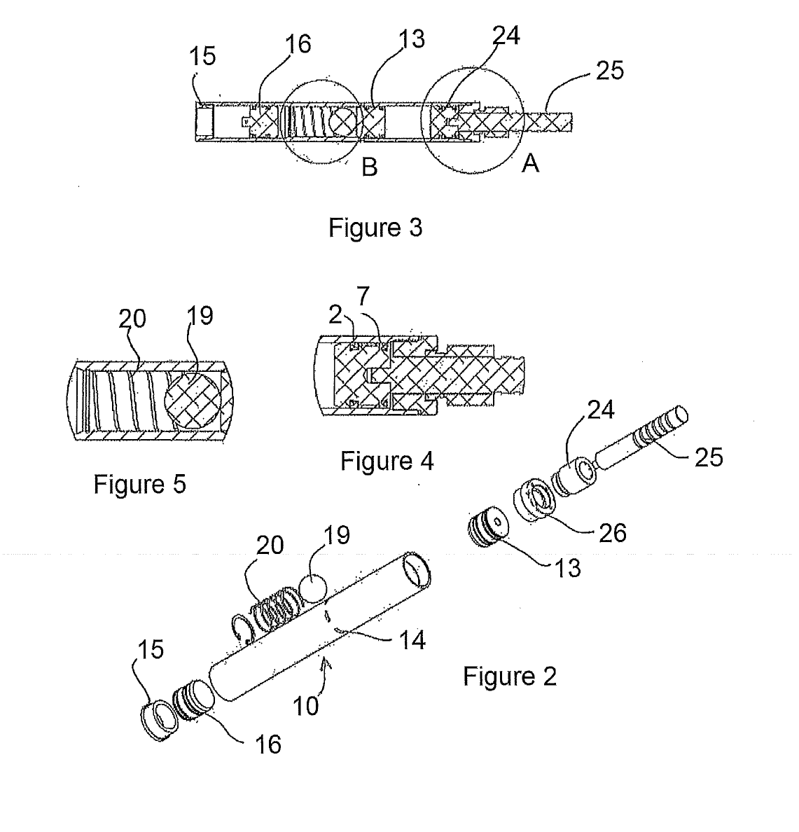

The body denoted generally by 10, takes the form of an open cylinder or tube as best shown in FIG. 2. The device can be made in a range of sizes depending on intended use or the depth of the targeted species, and the amount of attractant needed.

The main components comprise in one embodiment first and second chambers 11 and 12 respectively; a valve member 13; at least one, but preferably a number of discharge apertures 14 that alternate around the cylinder adjacent the junction between the first and second chambers; re-sealable caps 15, 15a for charging said first chamber and closing the second chamber respectively; an actuator 16; a piston assembly 17 and an optional mixing assembly 18.

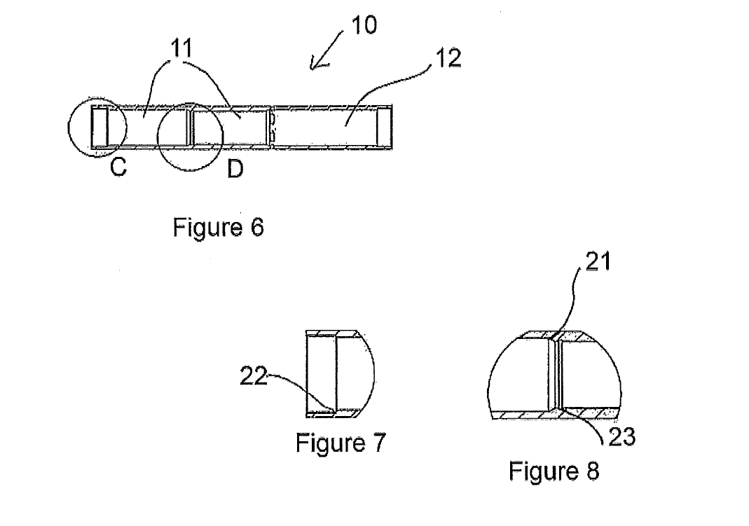

Referring to FIG. 6, the device body 10 is shown in cross section. The body is preferably made from a corrosion resistant material such as aluminium or an alloy thereof, but could also be made from stainless steel or plastics. Material choice will also be predicated on whether the device 10 is a reusable device, or a single use device.

The internal wall of the first chamber 11 is stepped as shown in FIG. 8. The purpose of this step is to provide a seat 21 at one end for the mixing assembly 18 and a second seat 23 for the valve member 13. The mixing assembly is an optional component and comprises a mixing ball 19 preferably of metal and a helical spring 20 (for example to retain the mixing ball or equivalent) which seats on seat 21. The purpose of the mixing assembly will be explained hereinafter.

The internal wall of the first chamber 11 is also stepped adjacent its end portion as shown by the numeral 22 in FIG. 7. This step is threaded (not shown) and is provided to house the re-sealable cap 15 which can be screwed thereon.

The piston assembly 17 is located in the second chamber 12 and further comprises a piston 24 slidably housed within the second chamber connected to a plunger 25 and a locking mechanism 26. The plunger 25 expediently has a calibrated scale 28 on its external surface calibrated to water depths. The scale 28 may just be locking locations for the locking mechanism 26 as shown, or may be in addition writing to show a desired set depth. Where desired set depths and pressures will vary, for example from fresh water to salt water, there may be a scale for each. Alternatively there may be a version of the device for fresh water, and one for salt water. In another form the calibrated scale 28 may be printed on the housing itself, for example on the second chamber and the second chamber, or a portion thereof is clear, such that the location of the piston 24 can be seen and adjusted according to the calibrated scale.

The valve member 13 similarly comprises a second piston 24 slidably housed within the second chamber adjacent the other end from the location of the piston assembly.

The actuator 16 further comprises a piston slidably housed within the first chamber.

A number of discharge apertures 14 alternate around the body adjacent the valve member 13. When the valve member 13 is in its closed position, the discharge apertures 14 are separated from first chamber 11 as shown in FIG. 1.

For expedience, the actuator 16, valve member 13 and piston 24 are of the same diameter and seal against the internal walls of the chambers by means of conventional O-ring/rubber seals 27 that are housed in annular slots machined into these components.

It will be appreciated that the device could incorporate additional features not essential to the invention. For example, attachment points for line, coloured portions to attract fish or additional weighted portions to aid sinking.

In another embodiment of the present invention there may not be a second chamber present. If no second chamber is present there may be a spring within the first chamber, for example mounted from a wall of the second chamber, pulling the valve member closed. The set pressure for release may still be adjustable, for example via a plunger through the valve member to add or decrease tension on the spring. This may again be done via notches or similar in the plunger, or the plunger may be threaded and engage with the valve member. Turning or one of the other will then adjust the tension and hence the set pressure.

The method of use will now be described. The re-sealable cap 15 and actuator 16 are removed and the first chamber 11 filled with a fish attractant to the desired amount. The actuator 16 may be adjustable in its location within the bore of the first chamber 11 to allow for differing amounts of fish attractant to be used. There may be a scale (not shown) to indicate the volume used, the actuator 16 may be depressed until the desired amount is present, the excess exiting via the discharge apertures. Fish oil has been found to be a suitable substance for this purpose although any commercial or homemade liquid or viscous may be used. The actuator 16 and cap 15 are then replaced.

Alternatively the actuator may be drawn back within the first chamber to act like a syringe and draw the fish attractant in to the desired volume, for example through the exit apertures.

The desired pressure is then set in the second chamber to ensure the valve member 13 does not unseat and release the fish attractant until the hydrostatic pressure in the water column, equal to the desired target depth has been reached. This can be achieved in a number of ways, for example by a gas, or a mechanical biasing means, such as, but not limited to, a spring, to act on the backside of the valve member 13.

In one preferred method a gas, preferably air, in the second chamber 12 is pressurised in order to urge the valve member 13 onto its seat. The desired pressure of the gas may be achieved by, use of a set pressure behind the valve 13 in chamber 12. This may be achieved by use of a plunger 25 depressed according to the scale 28 to the required depth and locked in place to move a piston 14. The piston in turn pressurises the gas in the second chamber on the back of the valve 13. Alternatively the second chamber 12 may be pressurized using an external source, such as a pump or canister, which can meter the pressure in. Alternatively or in addition there may be a scale with extends out the second chamber (similar to the piston 24 with a set pressure behind it between it and the cap 15a and plunger 25) which then shows the pressure in the second chamber 12.

In an alternative embodiment, instead of pressurizing a gas in the second chamber, a spring, for example helical, could be located the chamber to urge the valve member into contact with its seat. The tension in the spring could be increased/decreased. This could be increased in a stepped wise way, for example by compression of an equivalent to the piston 24 and plunger 25, again with a scale 28 to show the now set pressure and hence release depth. The tension could also be set by a threaded arrangement to increase and decrease the pressure of the spring on the back of the valve 13.

As the device descends down the water column, eventually the hydrostatic pressure in the water column will equal and then overcome the desired pressure (for example gas) in the second chamber 12 thereby forcing the valve member 13 to unseat. Opening of the valve member may occur through two different methods, or a combination thereof. A first is direct action of the hydrostatic pressure on the valve member, for example via the discharge apertures. This will then force the valve member to open these apertures to then allow release of the attractant from the first chamber.

Another method is indirect action, by the hydrostatic pressure. This occurs when the hydrostatic pressure acts on the actuator at the far end of the first chamber (away from the valve). The actuator then pushes on the fish attracting substance in the first chamber. The attractant is a liquid/viscous substance, and is incompressible, and it forms a hydraulic lock. Because the biasing means (e.g. gas or spring) in the second chamber can compress, the increasing pressure from the actuator and attractant eventually forces the valve member 13 to lift of its seat. This exposes the fish attracting substance to the discharge apertures 14. Because these substances are lighter than water, they also readily disperse into the surrounding water column. As above also the actuator 16 may also urge the fish attractant out.

In a less preferred form, not shown, the actuator may have a member between it and the valve member to thereby push the valve member open.

The device (after being tied to a suitable line and weighted if necessary—not shown in the drawings) is lowered into the water column. At the targeted depth, the hydrostatic pressure will equal and then overcome the desired pressure set in the second chamber and the valve member by the methods described above will open allowing the fish attracting substance to begin to be dispersed.

If, after a period of time has elapsed, it is necessary to bring the device back to the surface, if there is still sufficient attractant left in the first chamber, it will be diluted with water at least at the end portion of the chamber. The device may be vigorously shaken which causes the mixing ball 19 to reciprocate against the action of helical spring 20 and mix the remaining attractant/water.

The mixing assembly or equivalent may also be present if the device is stored for a period of time (for example prepared earlier, or bought from a store) to then ensure there is no separation of the fish attractant prior to use.

The foregoing description of the invention includes preferred forms thereof. Modifications may be made thereto without departing from the scope of the invention.

1-30. (canceled)

31. A device for dispensing a fish attracting substance comprising or including:
a housing having at least a first chamber;
said first chamber to hold a fish attracting substance;
at least one fish attracting substance discharge aperture;
a valve member to seal said at least one discharge aperture;
a gas or spring biasing means at least in part within said housing, to in use urge said valve means into sealing engagement with said at least one discharge aperture to a desired pressure, said biasing means being adapted for setting or being set to said desired pressure;
and wherein in use, an increase in hydrostatic water pressure external of said housing causes unseating of said valve member from said sealing engagement, once said desired pressure is met, with said at least one discharge aperture to then permit said fish attracting substance to discharge via said at least one aperture.

32. A device as claimed in claim 31 wherein there are a number of said discharge apertures around said cylinder adjacent a junction between said first chamber and a second chamber.

33. A device as claimed in claim 32 wherein the, or each, said discharge aperture is located in said second chamber.

34. A device as claimed in claim 32 wherein said housing is of a hollow cylindrical shape divided internally such that said first chamber is at one end and there is a second chamber at the other end.

35. A device as claimed in claim 34 wherein said first and second chambers are in communication with each other and separated by said valve member.

36. A device as claimed in claim 34 wherein said biasing means acts on a back side of said valve member facing into said second chamber.

37. A device as claimed in claim 34 wherein said biasing means is set to said desired pressure by a piston located in said second chamber of said housing.

38. A device as claimed in claim 37 wherein there is a calibrated scale on a plunger of said piston assembly or external to said housing, to allow setting of said desired pressure.

39. A device as claimed in claim 31 wherein there is a re-sealable opening for charging said first chamber, located at an end face of said first chamber.

40. A device as claimed in claim 31 wherein a gas is used as said biasing means.

41. A device as claimed in claim 31 wherein said valve member is unseated by either or both of:
a. direct action of said hydrostatic pressure on said valve member, and/or
b. indirect action of said hydrostatic pressure.

42. A device as claimed in claim 41 wherein said direct action is through said discharge apertures onto said valve member to unseat it.

43. A device as claimed in claim 42 wherein an actuator sits behind said fish attractant and urges said fish attractant toward said valve member, wherein when said valve member unseats, at least some of said fish attractant is caused to be released via said discharge apertures.

44. A device as claimed in claim 43 wherein said indirect action is via said actuator being exposed to said hydrostatic pressure to thereby unseat said valve member.

45. A device as claimed in claim 31 wherein there is a mixing element for the fish attracting substance which is preferably housed within the first chamber and comprises a ball bearing.

46. A device for dispensing a fish attracting substance comprising or including:
a housing having at least a first chamber;
said first chamber to hold a fish attracting substance;
at least one fish attracting substance discharge aperture, sealed between said first chamber and externally of said housing,
wherein said seal will open said at least one discharge aperture when a desired hydrostatic pressure external of said housing is met, said seal controlled by a gas or spring biasing means, at least in part within said housing, to control said seal to open said at least one discharge aperture at a desired pressure or depth, said biasing means being adapted for setting or being set to said desired pressure or depth,
with said at least one discharge aperture to then permit said fish attracting substance to discharge via said at least one aperture.

47. A device as claimed in claim 46 wherein said seal is a rupture seal designed to rupture at said desired hydrostatic pressure.

48. A device as claimed in claim 46 wherein said seal is provided by a valve biased against said discharge aperture by a set desired pressure, to match said desired hydrostatic pressure, said valve then opening said discharge aperture to allow release of said fish attractant.

49. A method of use of a device for dispensing a fish attracting substance according to claim 31, comprising or including the steps of,
charging said first chamber with a fish attracting substance,
charging said second chamber to a desired pressure equal to a hydrostatic pressure for a desired release depth,
wherein on release into a liquid environment said device will sink and at said desired release depth, release said fish attractant device.

50. A kit of parts for a device for dispensing a fish attracting substance, comprising or including,
a. a housing having at least first and second chambers;
said first chamber provided with a re-sealable opening for charging said chamber with a fish attracting substance;
at least one fish attracting substance discharge aperture;
a valve member to seal said at least one discharge aperture;
a biasing means at least in part within said second chamber to in use, urge said valve means into sealing engagement with said at least one discharge aperture to a desired pressure;
and an actuator movable, in use, by an increase in hydrostatic water pressure external of said housing to cause unseating of said valve member from sealing engagement, once said desired pressure is met, with said at least one discharge aperture to permit said fish attracting substance to discharge via said at least one aperture, and
b. a supply of one or more charges of fish attractant for charging said device.

51. A kit as claimed in claim 50 wherein said kit also includes a charge device to charge said second chamber to said desired pressure with a gas, said charge device being a pump, canister or similar.

52. A kit as claimed in claim 50 wherein said biasing means within said second chamber is a gas, or spring, adapted for setting to said desired pressure.
